(19) United States
(12) Patent Application Publication
(10) Pub. No.: US 2026/0299571 A1
(43) Pub. Date: Oct. 1, 2026

(54) Control System for a Technical Installation

(71) Applicant: Siemens Aktiengesellschaft, Muenchen (DE)

(72) Inventor: Benjamin LUTZ, Karlsruhe (DE)

(21) Appl. No.: 19/489,103

(22) PCT Filed: Mar. 13, 2024
(86) PCT No.: PCT/EP2024/056616

§ 371 Date: Dec. 1, 2025

(30) Foreign Application Priority Data
Jun. 2, 2023 (EP) 23177055.3

(51) Int. Cl. G05B 19/418

(52) U.S. Cl. CPC G05B 19/41885

(57) ABSTRACT

A control system for operating a technical installation includes expanded visualization information for a graphical presentation of the step chains for an operator of the technical installation, wherein process objects are assigned an image reference constructed as a data array and has at least two elements, where a first element has an assignment to a particular state transition object and a second element has an assignment to a particular installation image, an where the visualization generator is also configured to insert a particular installation image into the detailed representation or at a separate location via the image reference for a particular state transition object.

### CROSS-REFERENCE TO RELATED APPLICATIONS

This is a U.S. national stage of application No. PCT/EP2024/056616 filed 13 Mar. 2024. Priority is claimed on European Application No. 23177055.3 filed 2 Jun. 2023, the content of which is incorporated herein by reference in its entirety.

### BACKGROUND OF THE INVENTION

### 1. Field of the Invention

The invention relates to a control system for a technical plant, comprising an automation device, which is configured to allow previously projected or programmed sequence chains with previously projected or programmed modules to execute to control a technical plant, and in which process objects are assigned to the programmed modules, where the process objects comprise variables for process values, an operator station server and at least one operator station client connected to the operator station server, where the operator station server is configured to transmit items of visualization information to the operator station client, and where the operator station client is configured to display, via the items of visualization information, a graphical presentation of the sequence chains for an operator of the technical plant, where the control system further comprises a visualization generator which is configured to represent, based on the previously projected or programmed modules with their process objects, a view of states and state transitions of the sequence chains at the runtime of the sequence chains, in a plant image as state objects and state transition objects, and is further configured to represent a detailed representation of the state transition of the respective state transition object when the operator interacts with a state transition object.

### 2. Description of the Related Art

Within the meaning of the invention, programming of sequence chains is taken to mean the creation of a user program with the aid of an SFC editor for Sequential Function Charts (SFCs). Calculations can be projected in modules or SFC modules and be implemented in sequences, transitions or sequencers. In process automation, sequence chains or sequential controls are used for a state-controlled or event-controlled execution of production processes. The SFC sequential control controls functions created with CFC (Continuous Function Charts) via operating and state changes. SFCs are projected in an engineering station. The automation station- and operator station-specific data portions are compiled starting from a projected base and loaded from the engineering station into the corresponding automation device and into the corresponding operator station server. By way of the visualization generator, operators can monitor the states of the sequence chains and the state transitions at the runtime in the detailed representations, what are known as magnifiers, and also intervene manually if necessary.

During the course of operation and observation, the sequence chains can be monitored by operators to also be able to intervene manually in the flows in specific applications, for example, manual switching of a transition, and/or confirmation of a transition after an operating request.

According to the prior art, the visualized sequence chains (SFC Visu) at the runtime, in addition to the actual sequence chains, also offer visualized magnifiers, via which the operator can recognize, based on a connection, which conditions are required for the transition to the next step and to what extent they are currently already met.

EP 3 528 074 B1 describes a method for checking the relationship between a process alarm, which is visually represented on an operator client of a process control system, and an acoustically output process alarm, of a process object.

EP 3 067 768 B1 discloses an automation facility having at least one automation device and an operator system for visualizing and operating sequence chains of a sequential control, where objects generated from the sequence chains are processed during a RUN operation of the automation device, where the objects parameterize and activate CFC functions created via a Continuous Function Chart Editor and loaded into the automation device, and where the interaction and linkage between the objects and the CFC functions are effected via process values and control signals.

EP 3 968 107 B1 discloses a process monitoring system with at least one first operating unit which is connected to a server, and the server has a visualization service for monitoring an automation plant.

EP 1 351 109 A1 describes a system and method for efficient programming of automation systems with high data consistency. The core of the subject matter disclosed here is a data program that can run on a data processing apparatus and that uses a flow-oriented combinational logic. This logic is generated directly from a specific flowchart that includes the flows of the program to be executed as well as the associated combinational logic.

One disadvantage of the process monitoring systems is that it is often difficult for an operator to recognize from the magnifiers (signal flow plans) how and when a transition, i.e., a state transition, will be met since the logic circuits in the known detailed image are often very complex and no trend is to be derived from the current values which have been faded-in.

### SUMMARY OF THE INVENTION

It is an object of the present invention to provide control system that permits improved operation of sequence chains.

This and other objects and advantages are achieved in accordance with the invention by a control system in which an image reference is assigned to process objects, which image reference is constructed as a data array and comprises at least two elements, where a first element has an assignment to a specific state transition object and a second element has an assignment to a specific plant image, and where the visualization generator is further configured via the image reference for a specific state transition object, to also fade a specific plant image into the detailed representation or at a separate location.

This invention introduces detailed magnifiers of SFC sequence chains for more efficient and improved operation and observation of the process-engineering plant.

The inventor has recognized that the object model of the SFC magnifiers is to be expanded or the process objects are to be provided with an image reference, so in the visualization, not only the complex connections of the magnifiers for the transitions are available to the operator in the detailed images via the display, but also visualizations such as those known to him from the plant images and that assist him/her in being able to assess the situation better and more efficiently. When opening a magnifier for a state transition, it is now possible to access expanded items of information and, in a detailed magnifier representation, the project engineer has now made plant images created specifically for the SFC magnifier referenceable, where the operator station server has a configuration memory in which the process objects expanded by the image reference and the further plant images are stored, a visualization service is present in this case, which has a dynamization service, a screen object model and a representation service, and where the representation service is configured to access the stored items of information in the configuration memory if the detailed representation of a state transition object is opened by the operator on the operator station client in the sequence chain represented, and to pass them on to the screen object model.

The dynamization service is configured to perform a dynamization of the plant images faded into the detailed representation or at a separate location.

Accordingly, the screen object model of the SFC sequence chains has been expanded with the image reference to be able to embed plant image elements or entire plant images in the magnifiers. The representation service accesses the stored items of information relating to the plant image elements and plant images if the magnifier of a transition is opened by the operator, and feeds them into the screen object model for the visualization of the sequence chain view.

The operability is further improved if the further faded-in plant images are configured to give the operator visual feedback when a threshold value for the state transition of the state transition object is reached. By way of this invention, for example, a trend curve can be inserted in the magnifier, on the basis of which the operator can very accurately estimate when the threshold will be reached.

Furthermore, operating elements for operating the process objects or for changing the variables for the process values can be faded into the detailed representation or at a separate location.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The above-described properties, features and advantages of this invention and the manner in which they are achieved will become clearer and more clearly understandable in connection with the following description of an exemplary embodiment and will be explained in more detail in connection with the drawings, in which:

FIG. 1 shows a schematic representation of an inventive control system;

FIG. 2 shows a data structure; and

FIG. 3 shows graphical surfaces of the control system of FIG. 1.

### DETAILED DESCRIPTION OF THE EXEMPLARY EMBODIMENTS

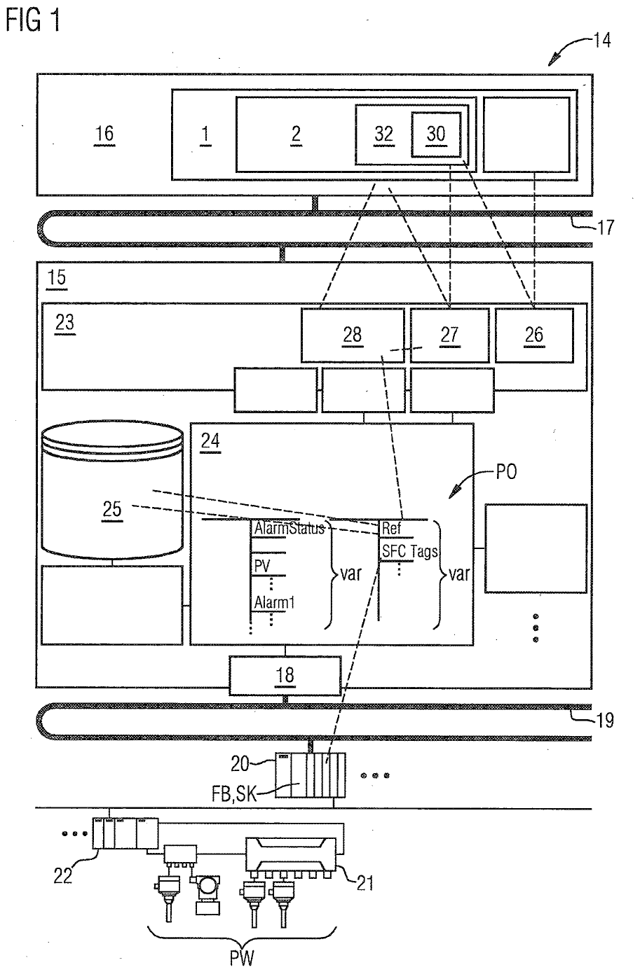

FIG. 1 schematically represents a control system 14 for the operation and observation of the technical plant configured as a process plant. The control system 14 comprises an operator station server 15 and an operator station client 16. The one operator station server 15 and the operator station client 16 are connected to one another via a terminal bus 17 and optionally to further components of the control system 14 (not represented), such as an archive server or an engineering station server.

For the purpose of operating and observing via the operator station client 16, an operator can access the operator station server 15 via the terminal bus 17. The terminal bus 17 can be formed, for example, as an industrial Ethernet, without being limited thereto.

The operator station server 15 has a device interface 18, which is connected to a plant bus 19. Via this device interface 19, the operator station server 15 is connected to an automation device 20 and to further components of the processing-engineering plant, such as peripheral devices 21, 22, and can communicate with them. Without being limited thereto, the plant bus 19 can be formed, for example, as an industrial Ethernet.

A visualization service 23, a process mapping 24 and a configuration memory 25 (inter alia) are implemented on the operator station server 15. The visualization service 23 integrated in the operator station server 15 initiates a transmission of items of visualization information to the operator station client 16. The operator station client 16 is configured to represent a visualization, i.e., a graphical presentation, in particular of graphical representations of technical objects, for operating and observing the process plant.

The automation device 20 is configured to control the technical plant. For this purpose previously projected or programmed sequence chains SK with previously projected or programmed modules FB are executed in the automation device 20.

Process objects PO are assigned to the modules FB, with the process objects PO comprising variables var for process values PW.

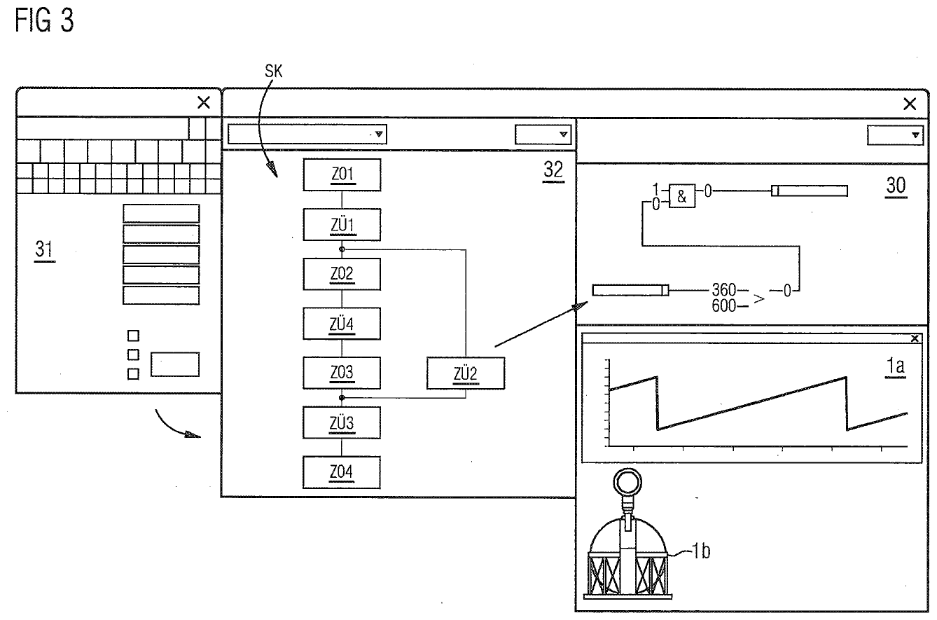

The visualization generator 2 is configured, based on the previously projected or programmed modules FB with their process objects PO, to represent a view of states and of state transitions, see FIG. 3 in this regard, of the sequence chains SK at the runtime of the sequence chains SK in a plant image 1 as state objects ZO1, ZO2, ZO3, ZO4 and state transition objects ZÜ1, ZÜ2, ZÜ3, ZÜ4, and is furthermore configured to represent a detailed representation 30 of the state transition of the respective state transition object ZÜ1, ZÜ2, ZÜ3, when the operator interacts with a state transition object ZÜ1, ZÜ2, ZÜ3.

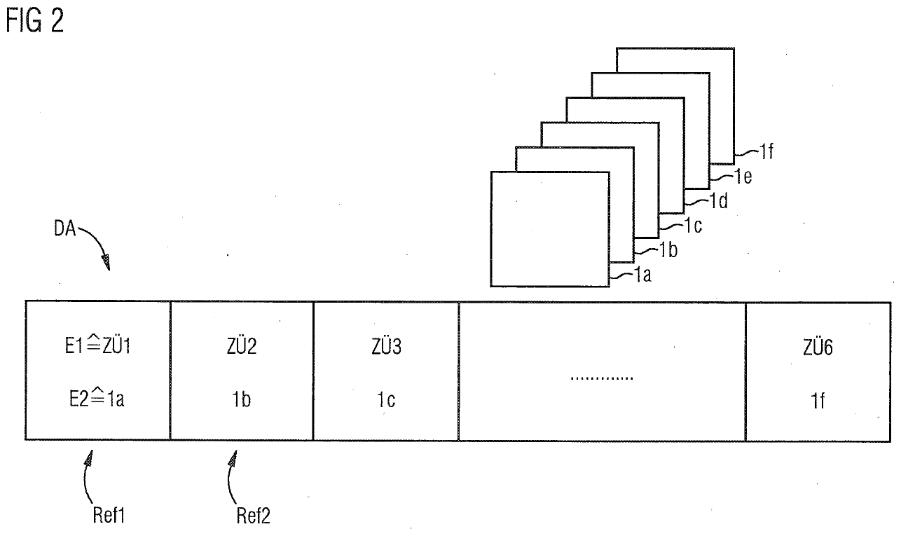

With reference to FIG. 1, an image reference Ref is assigned to the process objects PO, which is constructed as a data array DA, see FIG. 2, and comprises at least two elements E1, E2, where a first element E1 has an assignment to a specific state transition object ZÜ1, ZÜ2, ZÜ3 and a second element E2 has an assignment to a specific plant image 1a, . . . , 1f, and where the visualization generator 2 is further configured to also fade a specific plant image 1a, . . . , 1f into the detailed representation 30 or at a separate location via the image reference Ref for a specific state transition object ZÜ1, ZÜ2, ZÜ3.

The process objects PO expanded by the image reference Ref, and the further plant images 1a, . . . , 1f are stored in the configuration memory 25. The visualization service 23 works together with the dynamization service 26, the screen object model 27 and a representation service 28. The representation service 28 is configured to access the stored items of information in the configuration memory 25 if the detailed representation 30 of a state transition object ZÜ1, ZÜ2, ZÜ3 is opened by the operator on the operator station client 16 in the sequence chain SK represented, and to pass on the data, in particular the image reference Ref, to the screen object model 27. The dynamization service 26 is configured to perform a dynamization of the plant images 1a, . . . , 1f faded into the detailed representation 30 or at a separate location.

FIG. 2 represents the data array DA. The data array DA is constructed as a two-dimensional data array DA with a first element E1 and a second element E2. The first element E1 contains an assignment to a specific state transition object ZÜ1, . . . ZÜ6. The second element E2 has an assignment to a specific plant image 1a, . . . , 1f. Specifically for this data array DA, six state transition objects ZÜ1, . . . ZÜ6 can thus be correspondingly assigned to six different plant images 1a, . . . , 1f.

FIG. 3 represents different views, as can occur in a plant image 1 of an operator station client 16. A module view 31 shows a standardized interface for controlling an SFC by the user program or a user. In technical terms, the module view 31 is also referred to as faceplate. In the module view 31, there is then, for example, in an alarm line, a switching button with which a sequence chain view 32 can be called up. A sequence chain SK is represented in the sequence chain view 32. The sequence chain SK or the sequencer always starts with a starting state and ends with an end state. In this example, the start forms a first state object ZO1 and the end forms a fourth state object ZO4. A second state object ZO2 and a third state object 203 lie in between. In order to arrive at the second state object ZO2 from the first state object ZO1, a state transition object ZÜ1 has to be run through. In order to arrive at the third state transition object ZO3 from the second state transition object ZO2, a fourth state transition object ZÜ4 has to be run through, as a result of which the end of the sequence chain SK is likewise reached. In the selected example, there is a second state transition object ZÜ2, which represents a second transition, between the first state object ZO1 and the third state transition object ZÜ3. Assuming the process is currently located with its process objects PO and its variables var in the second state transition object ZÜ2, then an operator can now interact with the second state transition object ZÜ2 and accordingly call up a detailed representation 30. However, in accordance with the prior art, an operator could not do much with the detailed representation 30. Inventively, a first plant image la and a second plant image 1b are now faded into the detailed view 30 via the image reference Ref.

As represented, with the additional plant images 1a, 1b this invention can present the operator with a trend curve with which he can easily estimate when the expected transition threshold is reached. In addition, the second plant image 1b shows that a tank is involved here.

The exemplary embodiment of FIG. 3 shows the benefit and the application of the invention. The change in state in the sequence chain SK depends on a fill level of a tank being exceeded, as represented in the magnifier. As a result of the output of the current fill level in the magnifier, the operator can detect how high this currently is, although it is difficult for him/her to estimate when it is expected that the threshold will be reached. It is possible for him to estimate this better with the additional fading-in of the trend curve.

Further advantages are that magnifiers of sequence chains in the sense of operation and observation can become more detailed. Transitions or state transitions can be operated and observed more efficiently because, in addition to the visualized SFC with a module view 31 with a sequence chain SK and magnifier, no further plant images, and/or controls are necessary to be able to efficiently and safely observe or also operate transitions because they are now all already present and can be faded-in on the basis of the image reference.

A data array DA could be written thus:
Display Ref={Transition1, PlantDisplay1}; {Transition2, PlantDisplay2}

### Definition

A sequence chain is an alternating succession of sequences that trigger specific actions respectively, and transitions that cause the change from one sequence to another as soon as the corresponding further switching condition is met. Each sequence chain has exactly one start sequence and one end sequence as well as, in addition, any number of intermediate sequences, which through directed edges respectively via interposed transitions.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements that perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-4. (canceled)

5. A control system for a technical plant, comprising:
an automation device configured to allow previously projected or programmed sequence chains with previously projected or programmed modules to execute to control the technical plant;
process objects assigned to the programmed modules, the process objects comprising variables for process values;
an operator station server;
at least one operator station client connected to the operator station server, the operator station server being configured to transmit items of visualization information to the at least one operator station client, and the at least one operator station client being configured to display, via the transmitted items of visualization information, a graphical presentation of the programmed sequence chains for an operator of the technical plant;
a visualization generator configured to represent, based on previously projected or programmed modules with associated process objects, a view of states and state transitions of the programmed sequence chains at runtime of sequence chains in a plant image as state objects and state transition objects, and configured to represent a detailed representation of a state transition of a respective state transition object when the operator interacts with a state transition object,
wherein an image reference is assigned to the process objects, the image reference being constructed as a data array and comprising at least two elements, a first element having an assignment to a specific state transition object and a second element having an assignment to a specific plant image;
wherein the visualization generator is further configured, via the image reference for a specific state transition object, to also fade a specific plant image into the detailed representation or at a separate location; and
wherein the operator station server includes a configuration memory in which the process objects expanded by the image reference and the further plant images are stored, and includes a visualization service which includes a dynamization service, a screen object model and a representation service, the representation service being configured to access the stored items of information in the configuration memory if the detailed representation of a state transition object is opened by the operator at the operator station client in the sequence chain represented, and to pass them on to the screen object model.

6. The control system as claimed in claim 5, wherein the dynamization service is configured to perform dynamization of the plant images faded into the detailed representation or at a separate location.

7. The control system as claimed in claim 5, wherein further faded-in plant images are configured to provide the operator visual feedback when a threshold value for the state transition of the state transition object is reached.

8. The control system as claimed in claim 6, wherein further faded-in plant images are configured to provide the operator visual feedback when a threshold value for the state transition of the state transition object is reached.

9. The control system as claimed in claim 5, wherein operating elements for operating the process objects or for changing the variables for the process values are faded-into the detailed representation or at a separate location.

10. The control system as claimed in claim 6, wherein operating elements for operating the process objects or for changing the variables for the process values are faded-into the detailed representation or at the separate location.

11. The control system as claimed in claim 7, wherein operating elements for operating the process objects or for changing the variables for the process values are faded-into the detailed representation or at a separate location.
